(19) United States
(12) Patent Application Publication
(10) Pub. No.: US 2013/0127777 A1
(43) Pub. Date: May 23, 2013

(54) MULTI-PROCESSING TOUCH PANEL ASSEMBLY

(71) Applicant: Kai-Ti YANG, Taoyuan (TW)

(72) Inventor: Kai-Ti YANG, Taoyuan (TW)

(21) Appl. No.: 13/612,883

(22) Filed: Sep. 13, 2012

Related U.S. Application Data
(63) Continuation-in-part of application No. 13/300,636, filed on Nov. 20, 2011, now abandoned.

(51) Int. Cl. G06F 3/045

(52) U.S. Cl. 345/174

(57) ABSTRACT

A multi-processing touch panel assembly mainly includes a high transparent flexible surface layer, first inducting layer having a plurality of parallel first axis trace, insulated layer, second inducting layer having a plurality of parallel second axis trace, third inducting layer having a plurality of spacer on a surface thereof, and a substrate. The components are stacked in order to form a transparent touch panel assembly. The plurality of first axis trace is perpendicular to the plurality of second axis trace. The second inducting layer and the third inducting layer are arranged oppositely with a predetermined gap separated by the plurality of spacer. A capacitive touch sensing circuit is formed between the first inducting layer and the second inducting layer, and a resistive touch sensing circuit is formed between the second inducting layer and the third inducting layer.

The present invention is a continuation in part (CIP) of U.S. patent application Ser. No. 13/300,636 which is assigned to the applicant of the present invention, and thus the contents of Ser. No. 13/300,636 is incorporated into the present invention as a part of the present invention.

### FIELD OF THE INVENTION

The present invention relates to touch panel assembly, and particular to a touch panel having both capacitive touch sensing function and resistive touch sensing function.

### DESCRIPTION OF THE PRIOR ART

Touch panels are widely used in various electronic products. For example, the resistive touch panels are usually applied to small devices such as PDA, electric dictionary, cell phone, MP3 player or GPS. However, the capacitive touch panels are applied to touch pad or virtual key of a laptop.

Capacitive touch panels are operated by an instant capacity effect generated by a conductor or a user's finger touch so that the position being touched will be located by detection of the variation of capacitance. The capacitive touch panel can be conveniently operated by human finger so that the panel will not repeatedly sustain large stress and then deformed or damaged. However, finger operation is not as precise and sensitive as pen operation of resistive touch panel for the tip of pen can perform precise input and complicated writing. On the other hand, the conductive films inside the resistive touch panel assembly has limited lifetime under repeatedly stress and strain.

Therefore, capacitive touch panel and resistive touch panel has different advantages and disadvantages respectively. To combine the advantages of the two touch panels is an objective of the business. Known method to approach the objective is to stack the capacitive touch panel and the resistive touch panel as one assembly. Such composite touch panel having both capacitive touch sensing function and resistive touch sensing function has lower sensitivity and precision for the complicated layers stacked. The optic characteristics are also damaged by the thicker assembly.

### FIELD OF THE INVENTION

Accordingly, the primary object of the present invention is to provide a composite touch panel including a capacitive touch sensing function and resistive touch sensing function so as to have the advantages of both types of touch panel. By reducing some layers of the assembly, the sensitivity and operation precision can be improved. The visibility of the touch panel can be improved by reduce of the thickness of the assembly.

To achieve above object, the present invention provides multi-processing touch panel assembly having a flexible transparent surface layer; a first inducting layer of a transparent film having a plurality of parallel first axis trace formed by a plurality of capacitive induction-spot connected one by one; an end of each first axis trace being connected to a signal wiring formed to an edge of the touch panel; an flexible transparent insulated layer; a second inducting layer of a transparent film with well electric conductivity having a plurality of parallel second axis trace; each second axis trace having a plurality of capacitive induction-spot connected one by one; an end of each second axis trace being connected to a signal wiring formed to the edge of the touch panel; a third inducting layer of a transparent conductive film having electric nodes; spacers being formed uniformly on the surface of the conductive film; a peripheral of the conducting film being electrically connected to a signal wiring formed to the edge of the touch panel; and a transparent substrate. The components mentioned above are stacked in order to form a transparent assembly. The plurality of first axis trace is perpendicular to the plurality of second axis trace. The second inducting layer and the third inducting layer are arranged oppositely with a predetermined gap separated by the plurality of spacer. A capacitive touch sensing circuit is formed between the first inducting layer and the second inducting layer, and a resistive touch sensing circuit is formed between the second inducting layer and the third inducting layer.

Especially, the surface layer is a flexible transparent insulated film made of Polycarbonate (PC), Polythylene terephthalate (PET), or other material. The insulated layer is a flexible transparent insulated film made of PET, ink, light curing resin (UV glue), optic glue (OCA glue) or other material. The first and second inducting layers are transparent films with well electric conductivity such as Indium Tin Oxide film or Indium Zinc Oxide film. The layers both have a plurality of parallel separated trace formed by etching process. T substrate is a hard transparent plate made of Polycarbonate (PC), Polythylene terephthalate (PET), Polymethylmethacrylate (PMMA), Cyclic Olefin Copolymer (COC), or other material.

In an embodiment of the present invention, the multi-processing touch panel assembly further includes a second insulated layer and a fourth inducting layer between the second inducting layer and the third inducting layer. The second insulated layer is transparent and flexible. The fourth inducting layer of a transparent conductive film has electric nodes. A peripheral of the conducting film is electrically connected to a signal wiring formed to the edge of the touch panel. The fourth inducting layer and the third inducting layer are arranged oppositely with a predetermined gap separated by the spacers. A resistive touch sensing circuit is formed between the fourth inducting layer and the third inducting layer.

Wherein, the second insulated layer is a flexible transparent insulated film made of PET, ink, light curing resin (UV glue), optic glue (OCA glue) or other material. The first and second inducting layers are transparent films with well electric conductivity such as Indium Tin Oxide film or Indium Zinc Oxide film.

The various objects and advantages of the present invention will be more readily understood from the following detailed description when read in conjunction with the appended drawing.

### BRIEF DESCRIPTION OF THE DRAWINGS

FIG. 1 is a cross-section view of the present invention.

FIG. 2 is a cross-section view of the second embodiment of the present invention.

FIG. 3 is a schematic view showing capacitive induction-spots of an X axis inducting layer of the present invention.

FIG. 4 is a schematic view showing capacitive induction-spots of a Y axis inducting layer of the present invention.

FIG. 5 is a top view showing the assembly of the present invention.

FIG. 6 is a schematic view showing capacitive induction-spots of an X axis inducting layer of the second embodiment of the present invention.

FIG. 7 is a schematic view showing capacitive induction-spots of a Y axis inducting layer of the second embodiment of the present invention, and

FIG. 8 is a top view showing the assembly of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

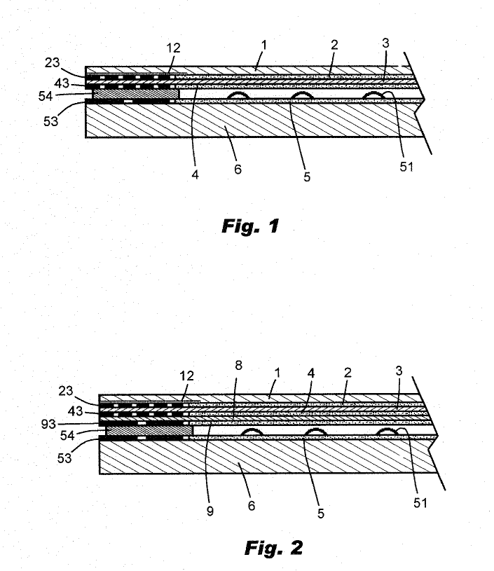

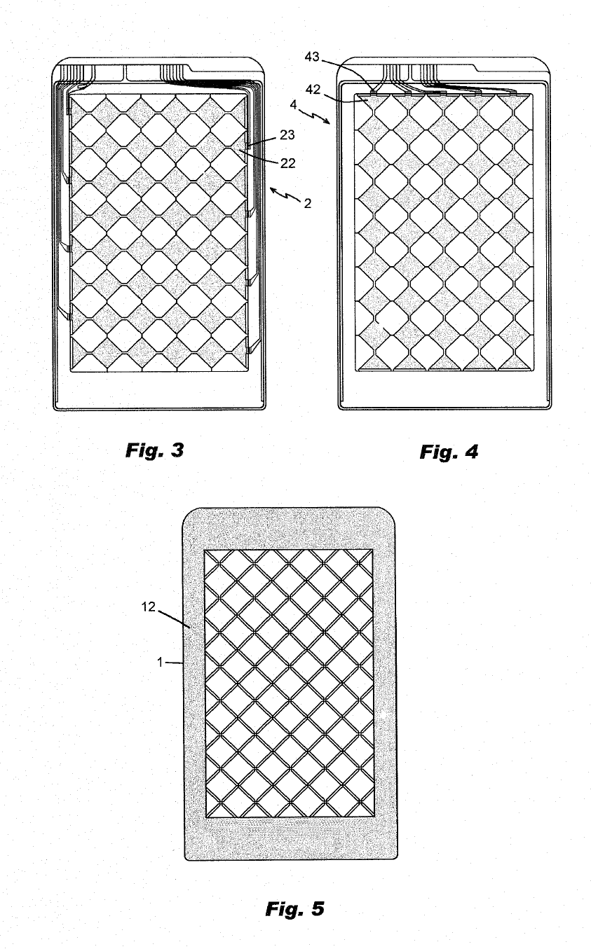

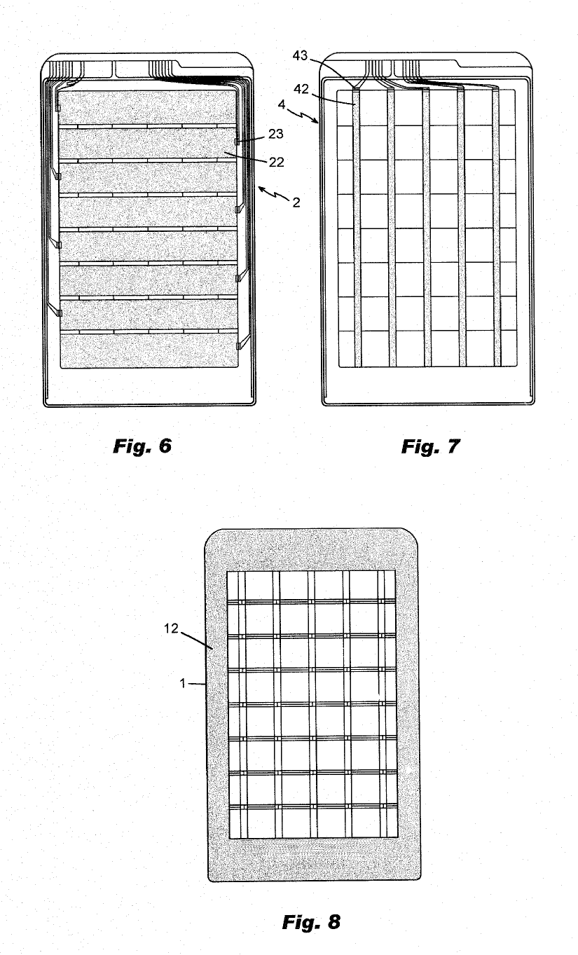

Referring to FIG. 1, a preferable embodiment according to the present invention includes a surface layer 1, X axis inducting layer 2, insulated layer 3, Y axis inducting layer 4, resistive inducting layer 5, and a substrate 6. The mentioned components are stacked in order so as to form a multi-processing touch panel. The surface layer 1 is a flexible, highly transparent insulated film made of Polythylene terephthalate, PET. The flexible, highly transparent insulated layer 3 is coated by ink. The X axis inducting layer 2, Y axis inducting layer 4, and the resistive inducting layer 5 are transparent films with well electric conductivity such as Indium Tin Oxide film or Indium Zinc Oxide film. The X axis inducting layer 2 includes a plurality of parallel transparent X axis trace. Each X axis trace has a plurality of capacitive induction-spot 22 connected one by one. The capacitive induction-spot 22 can be shaped as diamond (shown in FIG. 3) or rectangle (shown in FIG. 6) extending along the X axis. An end of each X axis trace is electrically connected to a signal wiring 23 formed to the edge of the touch panel. The Y axis inducting layer 4 includes a plurality of parallel transparent Y axis trace. Each Y axis trace has a plurality of capacitive induction-spot 42 connected one by one. The capacitive induction-spot 42 can be shaped as diamond (shown in FIG. 4) or rectangle (shown in FIG. 7) extending along the Y axis. An end of each Y axis trace is electrically connected to a signal wiring 43 formed to the edge of the touch panel. The resistive inducting layer 5 is a conductive film including electric nodes. A plurality of spacer 51 is uniformly arranged to the conductive film of the resistive inducting layer 5. The peripheral of the resistive inducting layer 5 is electrically connected to a signal wiring 53 formed to the edge of the touch panel. The substrate 6 is made of transparent hard material such as transparent glass, Polycarbonate PC, or polymethymethacrylate PMMA. A color frame 12 is formed near a peripheral of a lower surface of the surface layer 1 by means of metal evaporating so as to cover the conducting wiring 23, 43, 53 for better appearance.

Referring to FIGS. 5 and 8, the components mentioned above are stacked in order to form a multi-processing touch panel. Wherein, the X axis inducting layer 2 is arranged to the lower surface of the surface layer 1. The Y axis inducting layer 4 is attached to the X axis inducting layer 2 with the insulated layer 3 arranged between. The Y axis traces are perpendicular to the X axis traces and the capacitive induction-spots of the X and Y axis traces are aligned as matrix. The resistive inducting layer 5 is arranged to an upper surface of the substrate 6 and is attached to a lower surface of the Y axis inducting layer 4 by an insulated glue 54 around the edge. The Y axis inducting layer 4 and the resistive inducting layer 5 are arranged oppositely with a predetermined gap separated by the spacers 51.

Through the stacking assembling mentioned above, a capacitive touch sensing circuit is formed between the X axis inducting layer 2 and the Y axis inducting layer 4. When a finger or a conductor touches or slide on a certain position of the surface layer 1, a capacitive signal is inducted and transmitted through the signal wiring 34, 43 to a signal processing circuit so that the signal processing circuit can locate the position by the variation of the capacitance. Moreover, a resistive touch sensing circuit is formed between the Y axis inducting layer 4 and the resistive inducting layer 5. When a tip of a pen touches the surface layer 1 of the touch panel, the Y axis inducting layer 4 will be pressed down to conduct the resistive inducting layer 5 so as to form a sensing signal. The sensing signal will be transmitted through the signal wiring 43, 53 to the signal processing circuit. Through the variance of the sensing signal, the position being pressed can be located. The stacked layers above the resistive sensing circuit are very thin and flexible so that the sensitivity for sensing the touch of the resistive sensing circuit will not be effected. The stress impacting to the Y axis inducting layer 4 and the ITO film of the resistive inducting layer 5 will be buffered by those stacked layers for prevent damage.

The transparent multi-processing touch panel according to the present invention can be arranged in front of a display of electronic product for users to perform input by finger, conductor, or the tip of a pen following the instruction of the display. By the operation of the signal processing circuit, the touch panel will be operated through the sensing signal from one or both of the capacitive and resistive sensing circuit, automatically or manually selected.

Therefore, the present invention integrates the capacitive touch panel and the resistive touch panel as one to combine the functions and advantages of both touch panels. By simplifying the stacking assembling, the thickness of the assembling is decreased to improve the visibility and transparency of the touch panel. Moreover, the touch sensing sensitivity and precision can be improved as well.

Referring to FIG. 2, another embodiment of the present invention is illustrated. An insulated isolation layer 8 and an upper resistive sensing layer 9 are added between the Y axis inducting layer 4 and the resistive inducting layer 5. The insulated isolation layer 8 is a flexible transparent insulated layer such as a PET plate or a film of ink. The upper resistive inducting layer 9 is a transparent conductive film including electric nodes. The peripheral of the upper resistive inducting layer 9 is electrically connected to a signal wiring 93 arranged to the edge of the touch panel. The upper resistive inducting layer 9 is arranged to a lower surface of the insulated isolation layer 8, and the upper resistive inducting layer 9 is attached to the resistive inducting layer 5 below by the insulated glue 54 around the edge. The upper resistive sensing layer 9 and the resistive inducting layer 5 are arranged oppositely with a predetermined gap separated by the spacers 51. Therefore, a capacitive touch sensing circuit is formed between the X axis inducting layer 2 and the Y axis inducting layer 4, and a resistive touch sensing circuit is formed between the upper resistive inducting layer 9 and the resistive inducting layer 5 so as to combine the two touch sensing circuits in one assembling. Equivalent functions to previous embodiment can be achieved by the modification in the embodiment.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-processing touch panel assembly comprising:
a surface layer which is a highly transparent, flexible, insulated film;
first inducting layer of a transparent film with well electric conductivity having a plurality of parallel first axis trace; each first axis trace having a plurality of capacitive induction-spot connected one by one; an end of each first axis trace being connected to a signal wiring formed to an edge of the touch panel;
an insulated layer of a high transparent and flexible insulated film;
a second inducting layer of a transparent film with well electric conductivity having a plurality of parallel second axis trace; each second axis trace having a plurality of capacitive induction-spot connected one by one; an end of each second axis trace being connected to a signal wiring formed to the edge of the touch panel;
a third inducting layer of a transparent conductive film having electric nodes; spacers being formed uniformly on a surface of the conductive film;
a peripheral of the conducting film being electrically connected to a signal wiring formed to the edge of the touch panel; and
a substrate of a hard, transparent insulated plate;
wherein the components mentioned above are stacked in order to form a transparent assembly; the plurality of first axis trace is perpendicular to the plurality of second axis trace; the second inducting layer and the third inducting layer are arranged oppositely with a predetermined gap separated by the spacers; a capacitive touch sensing circuit is formed between the first inducting layer and the second inducting layer, and a resistive touch sensing circuit is formed between the second inducting layer and the third inducting layer.

2. The multi-processing touch panel assembly as claimed in claim 1, wherein an opaque color frame is formed near a peripheral of a lower surface of the surface layer.

3. The multi-processing touch panel assembly as claimed in claim 1, wherein the insulated layer is made of one of Polythylene terephthalate, ink, light curing resin, or optic glue.

4. The multi-processing touch panel assembly as claimed in claim wherein the capacitive induction-spot is shaped as diamond.

5. The multi-processing touch panel assembly as claimed in claim wherein the capacitive induction-spot is shaped as rectangle.

6. The multi-processing touch panel assembly as claimed in claim 1 further comprising, between the second inducting layer and the third inducting layer:
a second insulated layer of a highly transparent and flexible insulated film; and
a fourth inducting layer of a transparent conductive film having electric nodes; a peripheral of the conducting film being electrically connected to a signal wiring formed to the edge of the touch panel; the fourth inducting layer and the third inducting layer are arranged oppositely with a predetermined gap separated by the spacers; a resistive touch sensing circuit is formed between the fourth inducting layer and the third inducting layer.

7. The multi-processing touch panel assembly as claimed in claim 6, wherein the second insulated layer is made of one of Polythylene terephthalate, ink, light curing resin, or optic glue.
